(19) United States
(12) Patent Application Publication
(10) Pub. No.: US 2003/0211204 A1
(43) Pub. Date: Nov. 13, 2003

(54) Method of preparing beverages and beverage concentrates nutritionally supplemented with minerals

(76) Inventors: Christine C. Fields, Lake Zurich, IL (US); Sean L Traci, Wilmette, IL (US)

Correspondence Address: DAVID G. HENRY, 7th Floor, 900 Washington Avenue, P.O.Box 1470, Waco, TX, 77603-1470, US

(21) Appl. No.: 10/143,741

(22) Filed: May 10, 2002

(51) Int. Cl. A23K 1/175

(52) U.S. Cl. 426/74

(57) ABSTRACT

A method for preparing mineral fortified beverages and beverage concentrates involves forming a premix solution containing a highly soluble mineral salt, which is then combined with the final beverage or beverage concentrate product. This method provides beverages substantial levels of a solubilized mineral at a cost effective price without generating off flavors, tastes or mineral inter-actions currently resulting from most mineral fortification solutions.

### BACKGROUND INFORMATION

A. Field of the Invention

This application relates to beverages and beverage concentrates which are nutritionally supplemented with significant levels of soluble minerals. This application further relates to a method for preparing these beverages and concentrates.

B. Background of the Invention

The advantages of mineral fortification to conventional foods and beverages are now well understood. As the growing population continues to discover and become educated on the significant benefits of ensuring their diets contain essential minerals such as calcium, magnesium, potassium and zinc food and beverage manufacturers search for practical methods to ensure they provide adequate delivery methods. A positive correlation between calcium intake and bone mass has been found across many age groups. Magnesium is well understood in its role to maintain cardiovascular health, potassium for blood pressure maintenance and zinc for overall immune health.

During the period of late teenage to young adulthood, it has been found that a significant reduction in dietary calcium intake typically occurs. This is especially true of the female population where reduced dietary calcium intake usually happens much earlier in life compared to their male counterparts. Accordingly, females, as a class, are especially susceptible to a prolonged calcium deficit over their life span. This calcium deficiency has been linked to a greater incidence of osteoporosis in postmenopausal women. Furthermore, as with calcium, other essentially mineral deficiencies have been linked to several ailments and diseases currently prevalent in the nations growing and aging population.

Beverages can be an excellent delivery system for minerals allowing individuals to obtain the adequate RDA's with a wholesome or nutritionally based vehicle. For example, beverages which are consumed often by the general public at breakfast are fruit juice products. Inclusion of such a high level of calcium in say, orange juice, for example, requires consideration of a number of issues that include taste, solubility and cost effectiveness.

It has been found that direct addition of mineral sources, such as carbonates or hydroxides, to beverages can generate undesirable off-flavors, chalky palatability or cause desirable aroma and flavor compounds to be stripped from the beverage. Addition of salts such as chlorides and citrates at necessary levels can impart undesirable brackishness or tartness to the product. Furthermore several mineral salts have also been found to reduce the flavor intensity and quality, as well as the sweetness of the beverage. Therefore finding a mineral source that will not have a significant impact on the flavor profile of the product, providing a neutral-tasting, palatable outcome can be a difficult task.

Solubilzation of minerals in beverage concentrates, specifically juices, can be a very significant problem because of the high solids, low hydration levels in the product. However, solubilzation of minerals in single-strength beverage products can also be difficult due to the components present and the natural solubility characteristics of most mineral salts currently available. Some of the most economical mineral salts such as carbonates, phosphates or citrates can precipitate out of the beverage fairly rapidly, resulting in an inconsistent and unstable fortified product. Accordingly, the mineral source also needs to be added in a way that insures solubilzation of the salt in both single-strength beverages and juice concentrates.

Finally providing an economical and feasibly practical solution to the food and beverage industry can be the determining factor whether a product is fortified. The margins in several beverage applications such as fruit juices and juice drinks are extremely tight. Adding cost to the consumer can also be deemed as fiscally irresponsible when providing solutions to increase overall health and well being to the general population. Therefore, this factor, above all others, can be the most critical when evaluating the use and functionality of the present invention.

C. Background Art

The following represent known art, and reveals both the content and limitations of the existing art prior to the present invention:

U.S. Pat. No. 3,657,424 to Akins et al. issued Apr. 18, 1972, discloses the fortification of citrus juices, in single strength, diluted or concentrates, with sodium, calcium and chloride ions in amounts above what is naturally present in the juice. Calcium salts specified include the chlorides, citrates or phosphates, where calcium chloride is preferred for providing the desired chloride ion. The maximum amounts of calcium salts described in these fortified citrus juices are up and 0.04%.

U.S. Pat. No. 3,114,641 to Sperti et al., issued Dec. 17, 1963, discloses extended orange juice products obtained by diluting single-strength orange juice or concentrated orange juice. The minerals salts and organic acids incorporated are used to maintain the flavor of the diluted orange juice product. Raw ingredients include calcium chloride, magnesium chloride, sodium or potassium citrates, tartaric and malic acids (or their salts) all in extremely low quantities. These extended orange juice products are based on a dilution factor of 1:1 to 1:4 when single-strength juices are used or 1:12 to 1:16 when concentrated juices are used.

European Patent Application 75,114, published Mar. 30, 1983, discloses protein-containing fruit juice drinks enriched with vitamins and minerals. These drinks contain 30-90% fruit juice, 2 to 20% whey protein concentrate, and a mineral salt mixture of potassium, sodium, magnesium, calcium and phosphate. Calcium is present in these drinks at 0.01 to 0.3%. These drinks are prepared by combining a solution of juice containing the whey concentrate with an aqueous solution of lemon juice containing the mineral salt mixture. The calcium salts used in this mineral salt mixture are not specified.

U.S. Pat. No. 4,325,975 issued to Lindon et al, April 1982 which discloses a drinking water product which contains from 60 to 125 mg of calcium per liter of product, and contains smaller amounts of the essential mineral magnesium and the non-nutritionally essential elements strontium and lithium.

U.S. Pat. No. 4,851,221 issued to Pak et al, which discloses a liquid solution suitable for dietary calcium supplementation consisting essentially of calcium hydroxide, calcium carbonate or calcium oxide and citric acid.

In each of these patents described above the fortified beverage product that is disclosed fails to meet at least one of the desired criteria of a soluble mineral source. Thus, there clearly remains a need for a mineral fortified product that has acceptable taste and ease of use while still providing the necessary level of the mineral such as calcium. The fortification solution should also be readily produced, conveniently stored and cost effective.

U.S. Pat No. 4,722,847 to Heckert in February 1988, which discloses a method or process for the calcium fortification of fruit juice beverages and beverage concentrates, specifically orange juice. The fortified product contains from 0.05 to 0.26% wt % solubilized calcium in single strength fruit juice beverages and 0.15 to 1.30% by weight in juice concentrates, where the calcium salts specified can consists of calcium carbonate, calcium oxide, and calcium hydroxide. Furthermore to increase the solubility of the calcium salt and bring it into solution specific organic acids from 0.4 to 4% weight total acids in single strength fruit juice beverages and 1.2 to 20% weight total acids selected from a specific mixture of citric and malic acids between approximately 5:95 and 90:10 weight ratio.

U.S. Pat. No. 4,737,375 issued to Nakel et al, April 1988 which discloses the calcium fortification of carbonated beverages and beverage concentrates that incorporate from 0.06 to 0.15% wt % solubilized calcium, where the calcium salts specified can consists of calcium carbonate, calcium phosphate, calcium hydrogen phosphate and calcium hydroxide as well as the sour salts of calcium citrate and calcium malate and from 0.24 to 1.05% weight total acids selected from a specific mixture of citric, malic and phosphoric acid.

U.S. Pat. No. 6,106,874 to Liebrecht et al., August 2000 which describes a low pH nutritionally fortified beverage, specifically pectin free fruit juice, which incorporates selected calcium sources of calcium lactate gluconate and natural milk minerals or mixtures thereof. Furthermore the invention states the incorporation of a natural milk mineral in the range between 0.3% to 0.6% by weight.

U.S. Pat. No. 6,086,927 to Frielich et al., July 2000 which discloses a method for producing a calcium fortified food product by forming a mixture of calcium hydroxide and water or fruit juice where the calcium hydroxide is mixed in an amount from 2.6% to 3.6% weight to volume of the mixture. Mixing a phosphoric acid with the mixture to neutralize the calcium hydroxide or to achieve a pH range between 4-6.0, which as defined in claim 4 is between 3.1% to 4.3% weight to volume. Mixing calcium lactate with the mixture then finally mixing calcium phosphate with the mixture.

In each of these last four technologies, although one can achieve higher elemental calcium contents in the final mix, there exists a very specific set of raw materials and conditions that must be met to achieve a soluble, adequate level of the mineral in the final product. U.S. Pat Nos. 6,086,927 and 6,109,874 utilize relatively expensive raw materials to obtain adequate calcium levels. U.S. Pat. No. 4,722,847 and U.S. Pat. No. 4,737,375 describe the use of very specific ratios (5:95 to 90:10) of organic acids of only citric and malic acid and in infrequent cases phosphoric to achieve a soluble, adequate tasting calcium fortification solution which can be difficult to process in an average size juice bottling facility. Therefore a demand still exists to find a solution that incorporates readily available low cost mineral salts as the fortification solution to the food and beverage industries, while still maintaining adequate levels of these minerals and provide a good tasting product.

European Patent Application 1370118 describes a process for producing a highly soluble organic acid salt by dissolving a mixture of calcium lactate and calcium gluconate in the range of proportions between 0.4:1 to 1.1:1 by weight in from 2 to 4 parts by weight of water. The process is then further described where the organic acid salt solution is concentrated by boiling the mixture to form a 2:1 and 1:1 ratio of water to solids then spray dried to form a solid matter. This invention discloses the use of organic acid salts not the use of organic acids as raw materials Although it provides a highly soluble neutral tasting solution for calcium fortification, this comes at a significant economical disadvantage to the customer.

Furthermore no technology exists which provides a means of fortifying with other mineral solutions other than a calcium salt solution. As the awareness grows for the lack of other major minerals in the diet such as zinc, potassium, and magnesium there exists a requirement to develop a solution for fortification of these mineral salts which also provide an economical, adequate tasting product to the food and beverage industries.

### SUMMARY OF THE INVENTION

A. Objects

In view of the foregoing, it is an object of the present invention to provide a new and beneficial method for fortifying beverages with beneficial minerals.

It is another object of the present invention to provide a method for producing beverage concentrates for preparing fortifying beverages with beneficial minerals.

It is another object of the present invention to provide improved mineral fortified beverages and concentrates for preparing mineral fortified beverages.

B. Definitions

As used herein, the term water includes, but is not limited to, any potable water such as spring water, sterilized water, filtered water, reverse osmosis water, distilled water, carbonated or sparkling water, purified water, artesian water, ground water, mineral water, well water, municipal water, and mixtures thereof. Said water may or may not have a calcium concentration prior to being calcium fortified.

As used herein, the term “Ready-to-Drink (RTD) Replacement Meal Beverage” refers to any liquid beverage providing nutrition, including the vitamins and minerals known to be essential for human health, as well as protein, carbohydrate and/or fat, for example, including but not limited to Unilever's Slimfast(, Abbott's Ensure(, or Mead Johnson's Boost(.

As used herein, the term “nutritional” or “nutritionally supplemented” or mineral supplemented” or “mineral fortified” amount means that the mineral sources used in the practice of this invention provide a nourishing amount of the mineral. The nutritionally supplemented amount will generally comprise more than 5% of the Recommended Daily Allowance (RDA), preferably between approximately 10% and 100% RDA, most preferably between approximately 10% and 40% of the RDA, per unit portion of the food or beverage product. It must be recognized that the preferred daily intake of any mineral may vary with the user and mineral type. In general, the RDA of calcium will range from 800 mg to 1200 mg, the RDA for Potassium will range from 1900 to 5600 mg, for Magnesium will range from 300 to 400 mg and for Zinc will be 12 to 15 mg depending on the age, body weight, and gender of the individual.

As used herein, the term “elemental mineral content” means the amount of said mineral present in the final product as opposed to the amount of a mineral content in the mineral salt ingredient incorporated.

As used herein the term “beverage drink” means any carbonated or non carbonated beverage, flavored or non-flavored, which can be sweetened with typical nutritive sweeteners including but not limited to high fructose corn syrup, sucrose, dextrose or non-nutritive sweeteners including but not limited to aspartame, saccharine, tetrahelose or some combination thereof.

C. Heart of the Invention

In satisfaction of the above objects, and consistent with the above definitions, the present invention provides a new and useful methods and processes involving the use of an organic acid, or a mixture of organic acids, and a basic or acidic mineral salt or a mixture of mineral salts in the production of highly soluble neutral tasting fortified beverages, beverage concentrates, as well as the products resulting from such methods and processes

The present invention encompasses, and practice of the invention includes preparation of the following beneficially fortified beverages, beverage concentrates, and related consumables:

1. Single-strength fruit juice beverages, which are nutritionally supplemented with significant levels of minerals. These beverages are substantially free of added protein and comprise:

(a) between approximately 0.002 and 0.26% by weight solubilized mineral depending on the mineral salt and type;

(b) between approximately 0.4 and 4% by weight of an acid component comprising any one or a mixture of organic acids such as gluconic acid, lactic acid, phosphoric acid and citric acid in weight ratios between approximately 5:95 and 100:0;

(c) not less than approximately 30% fruit juice;

(d) a sugar content between approximately 2° and 16° Brix

2. Mineral supplemented fruit juice concentrates. These juice concentrates comprise:

(a) between approximately 0.005 and 1.30% by weight solubilized mineral, depending on the mineral salt and type;

(b) between approximately 1.2 and 20% by weight of an acid component comprising any organic acid or a mixture of organic acids such as gluconic acid, lactic acid, phosphoric acid and citric acid in weight ratios between approximately 5:95 and 90:10;

(c) at least about 30% fruit juice; and

(d) a sugar content of between approximately 5° and 75° Brix.

3. Nutritionally enhanced Isotonic Beverages. The Isotonic Beverages produced according to the present invention can comprise:

(a) between approximately 0.05 and 1.30% by weight solubilized mineral, depending on the mineral salt and type;

(b) between approximately 1.2 and 20% by weight of an acid component comprising any organic acid or a mixture of organic acids such as gluconic acid, lactic acid, phosphoric and citric acid in weight ratios between approximately 5:95 and 90:10;

(c) a water-soluble oligosaccharide (i.e. Glucose) content between the ranges of 1.2 to 5 weight % of the total product.

(d) additional energy enhancement ingredients, for example but not limited to, d-ribose, taurine and electrolytes to demonstrate an adequate an effective dosage.

(e) additional flavors, preservatives and colors to achieve the desired taste profile of the final product.

4. Nutritionally enhanced Ready to Drink meal replacement beverage. The drink mix can be comprised:

(a) between approximately 0.005 and 1.30% by weight solubilized mineral, depending on the mineral salt and type;

(b) between approximately 1.2 and 20% by weight of an acid component comprising any organic acid or a mixture of organic acids such as gluconic acid, lactic acid, phosphoric and citric acid in weight ratios between approximately 5:95 and 90:10;

(c) additional desired vitamins and minerals to achieve the desired level of nutrition in the final product.

(d) a carbohydrate content ranging between approximately 20 to 90 weight % of total caloric content which may be any edible carbohydrate based product for example but not limited to glucose or maltodextrin

(e) a protein content which can range between approximately 5 to 50 weight % of total caloric content which may be any edible protein in the form of for example but not limited to a hydrolysate or amino acid complex.

(f) a fat content which can range between approximately 2 to 20 weight % of the total caloric content which may be any edible natural and/or synthetic oil for example but not limited to safflower, soybean, or corn oil or essential amino acids for example but not limited to glycerol or alkyl esters.

(g) a emulsifier able to stabilize the liquid mixture for example but not limited to carrageenan.

(h) additional flavors and colors necessary to achieve the desired taste profile of the final product.

5. Mineral fortified water or near water beverages. These water beverages comprise:

(a) between approximately 0.005 and 1.30% by weight solubilized mineral, depending on the mineral salt and type;

(b) between approximately 1.2 and 20% by weight of an acid component comprising any organic acid or a mixture of organic acids such as gluconic acid, lactic acid, phosphoric and citric acid in weight ratios between approximately 5:95 and 90:10;

(c) potable drinking water

(d) other desired natural or artificial flavors, colors and electrolytes.

6. Other mineral fortified beverage drinks. These beverage drinks may contain:

(a) between approximately 0.005 and 2.50% by weight solubilized mineral, depending on the mineral salt and type;

(b) between approximately 1.2 and 20% by weight of an acid component comprising any organic acid or a mixture of organic acids such as gluconic acid, lactic acid, phosphoric and citric acid in weight ratios between approximately 5:95 and 90:10;

(c) a sugar—derived sweetener ranging between approximately 5% to 45% by weight, for example, but not limited to fructose, glucose, sucrose or high fructose corn syrup or a non calorie artificial sweetener substitute, for example, but not limited to saccharin, aspartame or cyclamates and the like ranging in weight % from 0.01 to 10% depending on the type of sweetener being used and the final desired taste of the final product.

(d) other desired natural or artificial flavors, colors and electrolytes.

(e) carbon dioxide introduced either into the water mixed with the beverage syrup or into the drinkable beverage to achieve carbonation which contains a range from 1.0 to 5 volumes of carbon dioxide. Refer L. F. Green, Developments in Soft Drinks Technology, Vol. 1, (Applied Science Publishers Ltd. 1978), pp. 102-107 (herein incorporated by reference), for a further description of beverage making, in particular the process for carbonation.

The methods and processes within the scope of the present invention, used to produce the above-referenced beverages, beverage concentrates, and related consumables, involves forming at least meta-stable aqueous premix solution of solubilized mineral from water, an acid component comprising from 0 and 90% by weight of gluconic, and/or between approximately 10 to 100% by weight lactic acid and/or between approximately 10 to 100% by weight of citric acid, and/or between approximately 5 to 60% phosphoric and a mineral source selected from a carbonate, oxide, hydroxide, acetate, sulfate, citrate or chloride in the calcium, potassium, magnesium or zinc forms. This premix solution of solubilized mineral is then combined with the beverage or beverage ingredients to provide a final beverage product that can be comprised of

a) A fruit juice having at least 0.05% solubilized calcium or 0.01% solubilized magnesium or 0.1% solubilized potassium or 0.0002% solubilized zinc; or any mixture thereof (b) at least about 30% fruit juice; and (c) a sugar content of between approximately 2° and 75° Brix.

b) Ready to Drink Nutritional Supplement Beverage having a total solids content of at least 12% which contains at least 0.05% solubilized calcium or 0.01% solubilized magnesium or 0.1% solubilized potassium or 0.0002% solubilized zinc or any mixture thereof.

c) Water or near water beverage containing at least 0.05% solubilized calcium or 0.01% solubilized magnesium or 0.1% solubilized potassium or 0.0002% solubilized zinc or any mixture thereof

d) Energy or sport drink containing at least 0.05% solubilized calcium or 0.01% solubilized magnesium or 0.1% solubilized potassium or 0.0002% solubilized zinc or any mixture thereof.

e) Beverage Drink, sweetened or unsweetened, carbonated or uncarbonated, containing at least 0.05% solubilized calcium or 0.01% solubilized magnesium or 0.1% solubilized potassium or 0.0002% solubilized zinc or any mixture thereof.

The process of addition and method for incorporation of the raw ingredients address several problems related to the addition of mineral salts to beverages today, namely the solubilzation of the salt, the off-colors and off-flavors produced by the addition of current mineral salts available or a significant reduction in cost associated with purchasing the higher solubility, neutral-tasting salts.

The present invention utilizes typical or common ingredients used in the beverage or beverage concentrates manufactured. However those skilled in the art are well versed on the additional ingredients and substitutes utilized to produce the desired beverage of choice. The intent of the present invention is to provide a solution to mineral fortification of beverages over a range of products and applications. Therefore, it is intended that the invention being disclosed herein should be limited only by the defined claims.

### DETAILED DESCRIPTION OF THE PREFERRED EMBODIMENTS AND PRACTICES OF THE PRESENT INVENTION

A. Preparation of Mineral Fortified Fruit Juice Beverages and Beverage Concentrates

In the fruit juice beverages the nutritional content can range anywhere from a minimum of 5% of the RDI for the specific mineral being fortified up to 40%. The weight % of the mineral will vary in the final beverage depending on the type of mineral being fortified, the type of mineral salt employed and the type of organic acid used to solubilize the mineral.

Fruit juice concentrates are typically 3× to 5× the concentration of the final juice product. Therefore the level of minerals is considerably higher and the elemental content can range from 20% to 60% of the RDI to achieve anywhere from 5% to 30% in the final beverage.

The fruit juice beverages and juice concentrates of the present invention contain the sugars normally present in fruit juice products. These sugars may include but are not limited to sucrose, fructose, high fructose corn syrup, glucose, invert sugar, and mixtures thereof. The amount of sugar naturally present in fruit juices is usually sufficient for the mineral fortified fruit juice beverages and juice concentrates of the present invention. However, in the case of shelf stable juice products, sugar is typically added, usually in the form of high fructose corn syrup. In addition to sugar, shelf-stable fruit juice beverages of the present invention can contain other sweeteners both nutritive and non-nutritive and non-caloric sweeteners including but not limited to saccharin, aspartame or others.

For single-strength fruit juice beverages, the sugar content can range between approximately 2° and 16° Brix. Typically, the sugar content of such beverages depends upon the amount of fruit juice contained therein. For full-strength beverages containing at least about 95% fruit juice, the sugar content is typically between approximately 5° and 15° Brix. For shelf-stable juice beverages that comprise between approximately 50 and 90% fruit juice, the sugar content is typically between approximately 5° and 14° Brix (no other sweetener) or between approximately 2° and 10° Brix (other sweetener containing).

For fruit juice concentrates according to the present invention, the sugar content can range between approximately 5° and 75° Brix. Typically, the sugar content of these juice concentrates is between approximately 20° and 50° Brix.

The levels of organic acids present depend on many factors including the desired solubility, taste profile, type of juice, and the desired elemental content in the final product serving. For fruit juice beverages having between approximately 0.05 and 0.26% by weight solubilized mineral, the level of organic acids can range between approximately 0.4 and 4% by weight. For juice concentrates used to prepare such beverages, the level of total acids can range between approximately 1.2 and 20% by weight. For beverages having between approximately 0.10 and 0.15% by weight-solubilized mineral, the level of total acids preferably ranges between approximately 0.8 and 1.8% by weight. Forjuice concentrates used to prepare such beverages, the level of total acids preferably ranges between approximately 2.4 and 9% by weight.

The present invention allows for a single organic acid to be used or a mixture of the said organic acids. The ratios of gluconic, lactic, phosphoric and citric in the acid component can vary depending on the taste profile desired and the limitations on the cost of product manufactured. Generally, the weight ratios of the acid mixtures are depicted as:

gluconic to lactic can be between approximately 5:95 and 90:10

gluconic to citric can be between approximately 20:80 and 90:10.

lactic to phosphoric can be between approximately 60:40 and 90:10

gluconic to phosphoric can be between approximately 50:50 and 95:5

lactic to citric can be between approximately 30:70 and 80:20 over the range of fruit juices available.

Other optional ingredients typically present in fruit juice products can be included in the beverages and concentrates of the present invention. For example, preservatives, vitamins and other minerals can be included. Suitable vitamins include A, D, E, C (ascorbic acid), B1, B2, B6, B12, niacin, folic acid, thiamine, biotin and riboflavin. Other minerals, which can be included, are iron, manganese, selenium and copper. If desired, natural and synthetic flavorings and colorings can be included in these beverages and concentrates.

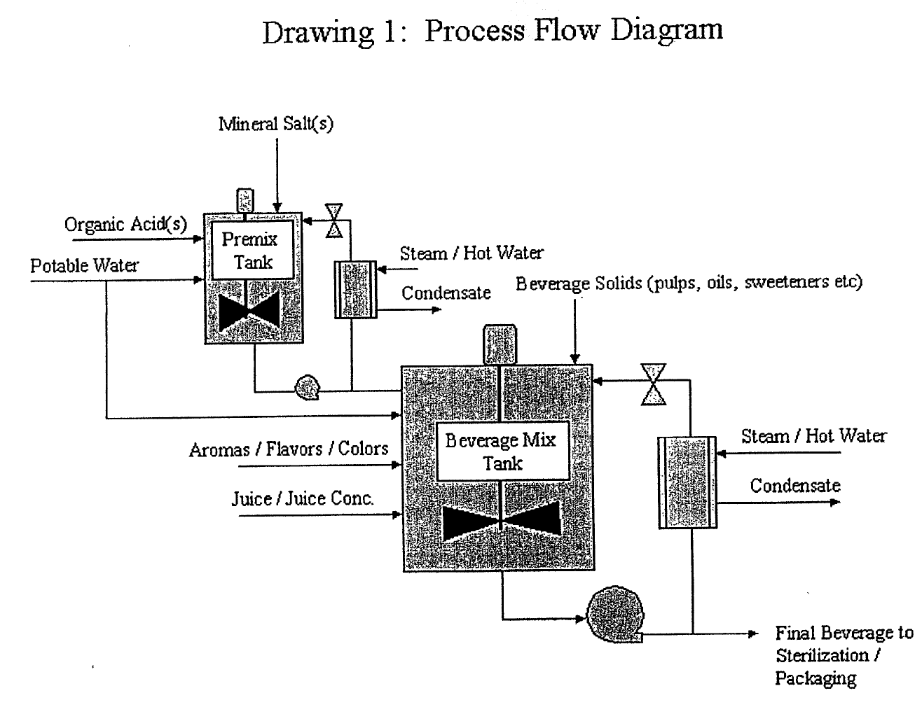

The mineral fortified fruit juice beverages are prepared by first creating a mineral solution then adding this mineral solution to the desired beverage to be fortified. A process flow diagram for the method is depicted in FIG. 1. This method or process for fortification of beverages can be followed for all beverage solutions described in the present invention including water or near water beverages, Isotonic Beverages (i.e. energy drinks), beverage drinks and RTD meal replacements. Conventional methods of preparing a fortified beverage typically include purchasing the final organic acid salt of the mineral desired then adding this dry solid salt to the beverage solution. The major advantages to present technology as opposed to conventional practices are the ability to reduce the cost of product manufactured by eliminating unnecessary drying, transportation and handling expenses, achieving the desired level of elemental mineral content in each batch while maintaining the solubility and taste profile of the final product.

As depicted in the drawing a solution of water and an organic acid is dissolved in the reactor by agitation and heating to (95( F. The mineral salt is then added in an amount necessary to fully react and deionize the acidic solution. The reaction is agitated and heated to (140( F. until the reaction has gone to completion, approximately 10 minutes (this can be verified by checking the pH of the organic acid solution). The second organic acid is then added in the organic acid salt solution and finally the remaining mineral salt needed to completely react the additional acid. The reaction is allowed to come to completion through agitation and heating to (160 deg F. The final organic acid solution is a highly soluble mineral source for incorporation into the desired beverage mixture. Throughout the reaction it is important to allow the carbon dioxide to dissipate or vent, this will not only speed the rate of reaction but also reduce the tendency to form off colors and flavors in the final mineral solution.

The mineral solution is then pumped over to the chilled concentrated juice holding tank at a level required to achieve the desired final mineral content in the beverage solution. While transferring the mineral solution to the beverage holding tank it is important to keep the mix tank well agitated and heated to ensure the mineral mixture achieves complete solubility and uniformity in the final product tank. The concentrated juice, aroma and flavor volatiles, pulp and peel oils used in this method can be obtained from published standards in fruit juice processing. References used include: Nagy et al., Citrus Science and Technology, Volume 2, (AVI Publishing Co. 1977), pp 177-252 for standard processing of oranges, grapefruit and tangerines & Nelson et al, Fruit & Vegetable Juice Processing Technology (3rd Ed., AVI Publishing 1980), pp.180-505 for standard processing of non-citrus juices such as apple juice, grape juice, pineapple juice, etc.

### EXAMPLE 1

Calcium Fortified Apple Juice

Basis=8 fluid Oz/240 mL

| Ingredient | Amount (grms) |
|---|---|
| 70° Brix Apple Juice Concentrate | 41.2 |
| Apple Aroma Concentrate | 28.01 |
| Gluconic Acid (50%) | 1.97 |
| Lactic Acid (88%) | 1.01 |
| Calcium Hydroxide | 0.56 |
| Water | 207.1 |
| Total | 279.85 |

The premix solution was prepared by dissolving the lactic acid in 55 g. of the water and then carefully adding 0.24 g calcium hydroxide while stirring at 140 F. Once dissolved (about 5 minutes) the second organic acid, gluconic acid was added and the remaining calcium hydroxide. The premix was heating up to 180 deg F. After CO2 dissipation ceased (about 10 min.), the premix solution was added to final product tank containing the 70. degree. Brix apple juice concentrate, the apple aroma concentrate and the remaining 152 g. of water. The mixture was stirred vigorously and then bottled to provide a calcium fortified apple juice beverage containing 30% of the RDA for calcium or 0.3 g.

### EXAMPLE 2

Magnesium Fortified Cranberry Juice

Basis=8 fluid Oz/240 mL

| Ingredient | Amount (grms) |
|---|---|
| Cranberry Juice | 18 |
| Concentrate | |
| Fructose (55%) | 26 |
| Gluconic Acid (50%) | 1.28 |
| Lactic Acid (88%) | 0.3 |
| Magnesium Oxide | 0.2 |
| Water | 185 |
| Total | 230.78 |
| Cranberry Flavors | 1.8 |

The magnesium fortified cranberry juice provides 30% of the RDA for magnesium at 120 mg and has a final lactate—gluconate weight ratio of 90:10.

### EXAMPLE 3

Zinc & Calcium Fortified Orange Juice

Basis=8 fluid Oz/240 mL

| Ingredient | Amount (grms) |
|---|---|
| 65 Brix Orange Juice | 45 |
| Concentrate | |
| Aqueous Orange | 6.75 |
| Essences | |
| Orange Pulp | 3.6 |
| Orange Oils | 0.09 |
| Lactic Acid (88%) | 0.6406 |
| Phosphoric Acid | 0.31 |
| (75%) | |
| Calcium Hydroxide | 0.56 |
| Zinc Oxide | 0.0093 |
| Water | 201.4 |
| Total | 258.3599 |

### EXAMPLE 4

Calcium Fortified Orange Juice Concentrate

Basis=8 fluid Oz/240 mL

| Ingredient | Amount (grms) |
|---|---|
| 65 Brix Orange Juice | 45 |
| Concentrate | |
| Aqueous Orange | 6.75 |
| Essences | |
| Orange Pulp | 3.6 |
| Orange Oils | 0.09 |
| Lactic Acid (88%) | 0.62 |
| Phosphoric Acid | 0.31 |
| (75%) | |
| Calcium Hydroxide | 0.56 |
| Water | 68 |
| Total | 124 |

Provides 30% of the RDI for Calcium at 0.3 grams

60% LA/40% PA

The premix solution was prepared by dissolving the lactic acid in the water and then adding 0.38 g of calcium hydroxide. The solution was heated to 140 deg F. and stirred continuously. Once full dissolved (about 5 minutes) the phosphoric acid was added to the premix solution. The remaining calcium hydroxide was added and the reaction was heated to 200 (F. The premix solution was allowed to stir continuously for 20 minutes and 15 g. of the 65 Brix orange juice concentrate was then immediately added. This premix solution had a total lactate to phosphate acid weight ratio of 60:40. The premix solution was added to the remaining 65(Brix orange juice concentrate, followed by the aqueous orange essences, orange pulp and orange oils. The resulting calcium fortified orange juice concentrate had a sugar content of 45(Brix, and contained 30% of the RDA for calcium or 0.3 g. When diluted with three parts water, this concentrate solution provides an orange juice beverage containing 98% orange juice.

It should be understood that the above Examples are merely illustrative of the invention being disclosed herein. Conventional and well-understood methods for the manufacturing of the juice beverages were employed and can deviate based on the juice manufacturer specifications and processing conditions. Given this disclosure, variations will occur to those skilled in the art. Accordingly, it is intended that the invention being disclosed herein should be limited only by the defined claims.

B. Preparation of Mineral Fortified Water Products

Mineral fortified water products are produced in the present invention by adding a sufficient amount of the organic acid necessary to solubilize the mineral salt required to achieve the desired mineral content in the final product serving.

A premix solution of a concentrated mineral salt is created by first:

a) dissolving a 2 to 30% by weight organic acid(s) in water by heating to anywhere from 95 to 200 deg F. and agitating the mixture between 20-200 rpm;

b) Adding the basic or acidic mineral salt(s) to the acid mix until dissolved

c) If required introducing the 1 to 28% by weight additional organic acid(s) to the mixture and allowing to dissolve by heating to anywhere from 95° F. to 200° F. depending on the acid being used and agitating between 30-80 rpm.

d) Adding the remaining mineral salt required to deionize the organic acid mixture.

The mineral salt may include but is not limited to calcium, magnesium, potassium or zinc or any mixture thereof.

When a mixture of organic acids is incorporated, the ratios of organic acids typically used are: 1) A 30% weight mixture of gluconic and lactic acid in the ratios between 40:60 to 90:10; 2) a 30% weight mixture of gluconic and citric acid in the ratios between 30:70 to 90:10;

3) a 30% weight mixture of gluconic and phosphoric acid in the weight ratios between 35:65 to 80:20; 4) A 30% weight mixture of lactic and citric acids in the weight ratios between 40:60 to 90:10; 5) A 30% weight mixture of lactic and phosphoric acids in the weight ratios between 50:50 to 95:5;

The calcium salt can be calcium carbonate, calcium hydroxide, calcium oxide, calcium phosphate, calcium sulfate, calcium chloride, calcium d-glucarate, or a mixture thereof. The magnesium salt can be magnesium oxide, magnesium hydroxide, magnesium chloride, magnesium citrate, magnesium sulfate or a mixture thereof. The potassium salt can be potassium oxide, potassium phosphate, potassium bicarbonate, potassium carbonate, potassium citrate, potassium chloride, potassium hydroxide, potasium hydrogen glucarate, potassium sulfate or a mixture thereof. The zinc salt can be zinc acetate, zinc oxide, zinc sulfate, zinc citrate, zinc carbonate or a mixture thereof.

Once the 30% concentrated mineral solution is produced it can be introduced to the potable water source, thoroughly mixed and then cooled. The fortified water products of the present invention are microbially stable. The processing methods used to achieve microbial stability will depend on the in house practices of the bottling facilities where the present invention is incorporated as well as the raw ingredients used in the product composition.

Several options are currently employed and can be effective at achieving microbial stability in the final product. Ozone treatment has been found to be effective with the organic acids of gluconate and lactate and is a widely accepted pasteurization method. Hot fill or thermal processing can be used with more highly thermodynamically stable compositions. Other methods which have been successful in achieving microbial stability of the fortified water compositions of the present invention include: microfiltration, irradiation, ultraviolet light, high intensity pulsed electric fields, pressure, carbonation, and combinations thereof.

### EXAMPLE 5

Calcium Fortified Water Beverage

Basis: 8 Fluid Oz Serving

| Ingredient | Amount (grams) |
|---|---|
| Potable Water | 226.83 |
| Gluconic Acid (50%) | 1.06 |
| Lactic Acid (88%) | 0.23 |
| Calcium Hydroxide | 0.19 |
| Total | 228.31 |

240 mL of a calcium fortified water are made by adding 0.23 g of lactic acid to 228 grams of water. The acid is dissolved by stirring. To this dilute acid 0.10 g of calcium hydroxide is added and the reaction is heated to 140 ( F. and stirred continuously for 5 minutes. The 1.06 g of gluconic acid are added to the mineral salt solution and dissolved at 180 ( F. The remaining mixture of calcium hydroxide is then added and the reaction is continuously stirred and heated for 20 minutes until all the CO2 has been dissipated. The fortified water solution is ozonated and filled in a 10 oz bottle. The fortified water contains 10% of the RDA for calcium or 0.1 g. The final gluconate to lactate weight ratio is 70:30.

### EXAMPLE 6

Calcium and Magnesium Fortified Sparkling Water

Basis=8 fluid Oz/240 mL

| Ingredient | Amount (grams) |
|---|---|
| Spring Water | 226.83 |
| Gluconic Acid (50%) | 1.95 |
| Lactic Acid (88%) | 0.3 |
| Calcium Hydroxide | 0.19 |
| Magnesium Oxide | 0.07 |
| Total | 229.34 |

240 mL of calcium and magnesium fortified, sparkling water containing is made by adding 1.95 grams of lactic acid to 228 grams of water. Adding 0.19 grams of calcium hydroxide until the calcium salt is dissolved, heating the mixture to 160 ( F. for 10 minutes. To this mineral solution 0.3 grams of lactic acid is added then 0.07 grams of magnesium oxide stirred continuously and heated to 180 ( F. until fully dissolved. The reaction is allowed to cool. The cooled fortified water solution is sent through UV filtration then bottled and carbonated with 4 volumes of CO2. The fortified sparkling water contains 10% of the RDA for calcium at 0.10 grams and 10% of the RDA for magnesium at 0.04 grams.

It should be understood that the above Examples are merely illustrative of the invention being disclosed herein. Given this disclosure, variations will occur to those skilled in the art. Accordingly, it is intended that the invention being disclosed herein should be limited only by the defined claims.

C. Preparation of a Mineral Fortified Isotonic Beverage

The process for incorporation of the mineral salt concentrate into the isotonic beverage follows the same methodology as a water or near water beverage with the incorporation of additional ingredients of a typical isotonic beverage to achieve the desired level of carbohydrates, electrolytes, other energy enhancement additives as well as colors and flavors. The present invention describes a method for fortifying these specific types of beverages with minerals, namely calcium, magnesium, potassium and zinc. One could also apply other minerals salts such as, but not limited to copper, iron, and selenium to achieve additional mineral salt fortification.

### EXAMPLE 7

General Purpose Calcium Fortified Sport Drink

Basis—1 Liter

| Ingredient | Amount (grms) |
|---|---|
| Saccharose | 55 |
| Oligosaccharides | 20 |
| Citric Acid | 1.8 |
| Citric Aroma | 1 |
| Sodium Chloride | 1 |
| Gluconic Acid | 0.2 |
| Lactic Acid | 1.96 |
| Calcium Hydroxide | 0.76 |
| Water | 958.32 |
| Total | 985.04 |

Fruit Punch Flavor to Taste

Provides 30% of the RDI for Calcium at 0.30 Grams Per Serving

### EXAMPLE 8

General Purpose Magnesium Fortified Energy Drink

Basis=1 Liter

| Ingredient | Amount (grms) |
|---|---|
| Glucose | 1.4 |
| D-Ribose | 1.8 |
| Maltodextrin | 5 |
| Dihydrogen Phosphate | 0.02 |
| Sodium Chloride | 0.02 |
| Lactic Acid | 0.45 |
| Citric Acid | 0.26 |
| Magnesium Oxide | 0.13 |
| Water | 958.32 |
| Total | 967.4 |

Provides 20% of the RDI for Magnesium at 0.08 grams MG It should be understood that the above Examples are merely illustrative of the invention being disclosed herein. Given this disclosure, variations will occur to those skilled in the art. Accordingly, it is intended that the invention being disclosed herein should be limited only by the defined claims.

D. Preparation of a Mineral Fortified Ready to Drink Meal Replacement Beverage

The present invention describes a method to fortify and solubilize mineral salts into a RTD Meal Replacement Beverage. The method follows the same procedure as stated above in the Fruit Juice or Fruit Juice concentrate beverage application where a premix mineral salt solution is made then added to the already stable RTD beverage. The intent of this method is to fortify an existing RTD formulation not to create in any way a new RTD Meal Replacement Beverage. The present invention incorporates an example described by Larson et al, in U.S. Pat. No. 4,497,800 issued February 1985. As an example we have removed the calcium, magnesium, potassium and zinc salts from the formulation stated in U.S. Pat. No. 4,497,800 to replace them with the technology incorporated by the present invention.

### EXAMPLE 9

RTD Nutritionally Fortified Meal Replacement Beverage.

| Ingredient | Amount/1 Liter | Units |
|---|---|---|
| Protein: | | |
| casein hydrolysate | 45.3 | G |
| L-methionine | 0.54 | G |
| L-tyrosine | 0.43 | G |
| L-tryptophan | 0.18 | G |
| Fat: | | |
| safflower oil | 3.1 | G |
| soy oil | 0.17 | G |
| Carbohydrate: | | |
| maltodextrin (DE 8-12) | 204 | G |
| corn starch | 13 | G |
| Vitamins: | | |
| tocopheryl acetate (E) | 0.1 | G |
| vitamin A palmitate | 0.47 | Mg |
| cholecalciferol (D₃) | 0.63 | Mg |
| phytonadione (K₁) | 0.34 | Mg |
| choline bitartrate | 0.61 | G |
| thiamine hydrochloride (B₁) | 0.32 | Mg |
| riboflavin (B2) | 2.75 | Mg |
| biotin trituration, 1% | 20.8 | Mg |
| niacinamide | 32.8 | Mg |
| calcium pantothenate | 18.13 | Mg |
| pyridoxine hydrochloride (B₆) | 3.59 | Mg |
| folic acid | 0.285 | Mg |
| vitamin B₁₂, 0.1% in gelatin | 10.4 | Mg |
| sodium ascorbate | 0.469 | G |
| Minerals: | 1.85 | G |
| Gluconic acid (50%) | 39.36 | G |
| Calcium hydroxide | 1.85 | G |
| Citric acid | 11.50 | G |
| Lactic Acid (88%) | 5.93 | G |
| potassium hydroxide | 10.04 | G |
| Calcium d-glucarate (d-saccharic acid | 1.0 | G |
| calcium salt, tetrahydrate) | | |
| magnesium oxide | 1.32 | G |
| zinc oxide | 0.075 | G |
| Copper gluconate | 8.2 | G |
| Manganese gluconate | 24.36 | G |
| Ferrous Gluconate | 83.18 | G |
| Stabilizers: | | |
| diacetyl tartaric acid | 0.198 | G |
| esters of mono-diglycerides | | |
| carrageenan | 0.441 | G |
| Citric Acid | 4.45 | G |
| H₂O | 865 | G |

Provides Per 8 oz Serving:

50% of RDI for Potassium

1750 mg

50% of RDI for Calcium

500 mg

50% of RDI for Magnesium

200 mg

100% of RDI for Zinc

15 mg

Add the following ingredients until uniformly dispersed in 380 g of water: 204 g maltodextrin solids, 45.4 g casein hydrolysate (approximately 82% protein equivalent content), 13.015 g modified corn starch solids, 0.607 g choline bitartrate, 1.84 g calcium glycerophosphate, 0.542 g L-methionine, 0.427 g L-tyrosine and 0.179 g L-tryptophan. This resulting liquid mixture is stirred and a solution of 2.5 g citric acid, 8.2 mg copper gluconate, 83.18 mg ferrous gluconate, 24.36 mg manganese gluconate and 1.0 g of calcium d-glucarate in 100 mL of water and is added and stirred in thoroughly. The pH of this stirred liquid mixture is adjusted to approximately 4.40 with a 25-50% water solution of citric acid. Further dilution of this main aqueous mixture is then achieved by adding an additional 200 g of water.

A fat solution is prepared in a separate vessel by stirring together, while heating to 145( F., 3.1 g of safflower oil and 0.198 g diacetyl tartaric acid esters of mono-diglycerides. To this heated fat solution is added 0.285 g of a preblend of fat soluble vitamins comprised of 0.173 g soy oil, 0.103 g dl-.alpha.-tocopheryl acetate, 4.715 mg vitamin A palmitate, 0.634 mg cholecalciferol, and 0.344 mg phytonadione. Stirring is continued until the vitamin preblend is completely dissolved at which point 0.441 g carrageenan powder is added and stirred thoroughly to insure complete wetting of the powder with the oil phase.

The main aqueous liquid mixture is heated to 120( F. and stirred while the above-described fat solution (at 120°-145° F.) is slowly added. The resulting liquid mixture is then passed through a two-stage homogenizer with a valve setting of 2500 psig pressure in the first stage and 500 psig in the second stage. Following homogenization, the temperature is reduced to below 50 ( F. by the application of cooling. Sufficient water is then added at this point to adjust the solids content and 25%. The exact amount of water to be added must be determined by analytic measurement but typically an amount of water totaling about 100 g is required.

In 50 mL water the following vitamin and mineral ingredients are dissolved: 3.046 mg thiamine hydrochloride, 2.750 mg riboflavin, 20.180 mg biotin trituration (1%), 31.728 mg niacinamide, 18.103 mg calcium pantothenate, 3.96 mg pyridoxine hydrochloride, 0.285 mg folic acid, 10.340 mg vitamin B12 (0.1% in gelatin), 0.469 g sodium ascorbate and 0.116 mg potassium iodide. This solution is then added to the main liquid mixture.

As an example to describe the new order of addition and method of incorporation of the present invention a 50% by weight mineral solution of calcium and zinc is made in a separate mixture by adding 39.36 grams of gluconic acid to 140 grams of water. The gluconic acid solution is heated to 180 ( F. then 1.85 grams of calcium hydroxide is added. After the calcium salt is solubilized (about 5 minutes) 0.07 grams of zinc oxide are then added and solubilized in the in the organic acid mineral mixture at a temperature of 200( F. for 20 minutes.

The soluble neutral-tasting mineral solution, which provides 50% of the RDA for calcium at 500 mg and 100% of the RDA for zinc at 15 mg, is then added to the main liquid mixture.

A second mineral salt solution of magnesium and potassium is made in a separate mixture by adding 5.93 grams of lactic acid to 20 grams of water. Heating the acid mixture to 140 ( F. and then adding 1.32 grams of magnesium oxide while stirring for about 15 minutes until the magnesium is fully dissolved. Then adding 7.5 grams of citric acid to the mineral mixture while continuing to heat and stir and adding 10.04 grams of potassium hydroxide until the KOH is fully dissolved and the pH of the mineral solution is above 4.5. The mineral mixture will contain 50% of the RDA for both potassium at 1750 mg and magnesium at 200 mg. The magnesium-potassium mineral solution is then added to the main liquid mixture and stirred until all components are evenly distributed.

The resulting non-sterile composition is filled into 8 oz glass bottles and commercially sterilized.

It will be understood by those skilled in the art that variations and modifications made to this specific example in light of the example utilized and the descriptions given above may be employed without departing from the scope of the invention as defined in the appended claims.

E. Preparation of Mineral Fortified Beverage Drinks

A soluble liquid mineral solution is made in a premix tank as described above in the fruit juice beverage preparation. The mineral solution is then added to a final beverage mixture consisting of either nutritive or non-nutritive sweeteners, flavors, preservatives and water. The final mineral fortified beverage is then bottled and may or may not be carbonated.

### EXAMPLE 10

Zinc Fortified Apple Juice Drink

16 fluid Oz Bottle (2 servings)

| Ingredient | Amount (grms) |
|---|---|
| Water | 263.04 |
| 55 HFCS | 142.8 |
| Lactic Acid | .0413 |
| Zinc Oxide | .018 |
| Apple Juice Concentrate | 3.2 |
| Sodium Benzoate | 0.36 |
| Total | 409.45 |

This zinc fortified apple drink contains 100% of the RDA for Zinc at 15 mg.

### EXAMPLE 11

Calcium Fortified Carbonated Lemon Line Beverage

16.9 fluid Oz Bottle (2 servings)/500 mL

| Ingredient | Amount (grms) |
|---|---|
| Water | 263.04 |
| 55 HFCS | 142.8 |
| Gluconic Acid (50%) | 2.4 |
| Citric Acid (dry) | 0.88 |
| Calcium Hydroxide | 0.74 |
| 85% Phosphoric Acid | 2.24 |
| Sodium Benzoate | 0.36 |
| Total | 412.46 |
| Lemon Lime Flavor to taste | @.45 mL |

This beverage syrup was added to a 16 oz. bottle at 412 grams/bottle. A lemon/lime flavor 0.45 ml. was then added. Carbonated water at 4.68 volumes CO2 was then added to the bottle to make 16 oz. (volume basis) of finished beverage having a carbonation level of 3.0 volumes CO2 and a pH of 4.4. The lemon line calcium fortified beverage contains 20% of the RDA at 200 mg with a weight ratio of gluconate-citrate at 50:50.

### EXAMPLE 12

Low Calorie Non-Carbonated Potassium Fortified Berry Fruit Flavored Drink

Basis=8 Fluid Oz/240 mL

| Ingredient | Amount (grams) |
|---|---|
| Water | 120 |
| 90 HFCS | 4.36 |
| Lactic Acid | 1.33 |
| Gluconic Acid | 2.37 |
| Potassium Hydroxide | 2.37 |
| Sodium Benzoate | 0.16 |
| Aspartame | 0.09 |
| Total | 130.68 |
| Berry Flavor to taste | @2 grams |

The beverage was added to a 10 oz. bottle at 130 grams/bottle. Berry flavor at 2.22 grams, 1.8 grams of a 10% citric acid solution, and 95 grams of water were then added to the bottle. The potassium fortified berry flavored drink contains 10% of the RDA at 350 mg. The final product gluconate-lactate weight ratio is 60:40.

### EXAMPLE 13

Calcium Fortified Single Strength Orange Juice Not From Concentrate (NFC)

Basis=8 Fluid Oz/240 mL

| Ingredient | Amount (grams) |
|---|---|
| SS OJ NFC (11.4 Brix) | 237.0 |
| Lactic Acid | 1.02 |
| Gluconic Acid | 1.98 |
| Calcium Hydroxide | 0.55 |
| Water | 7.30 |
| Total | 247.85 |

It should be understood that the above Examples are merely illustrative of the invention being disclosed herein. Given this disclosure, variations will occur to those skilled in the art. Accordingly, it is intended that the invention being disclosed herein should be limited only by the following claims.

What is claimed is:

1. A method for preparing a mineral supplemented beverage product comprising the steps of:
(a) forming an at least meta-stable aqueous premix solution of solubilized mineral comprising:
(i) a mineral salt constituting between approximately 0.005 and 1.5% by weight elemental content of said beverage product.
(ii) an organic acid component between approximately 0.1 and 25.0% by weight of said beverage product. and
(iii) water;
(b) combining said aqueous premix solution of the solubilized mineral with a beverage substrate in solution.

2. The method of claim 1 wherein the premix solution of a soluble mineral is formed by the steps of:
(a) forming an aqueous solution containing said organic acid component; and
(b) adding said mineral salt to the acid component-containing solution.

3. The method of claim 1 wherein the said beverage substrate is a fruit juice.

4. The method of claim 3 wherein said organic acid component comprises between approximately 10 and 100% by weight of one or more acids selected from a group consisting of lactic acid, phosphoric acid, citric acid or gluconic acids.

5. The method of claim 1 wherein the said beverage product is a water or near water and wherein said organic acid component comprises between approximately 10 and 100% by weight of one or more acids selected from a group consisting of lactic acid, phosphoric acid, citric acid or gluconic acids.

6. The method of claim 1 wherein said beverage product is a fruit juice concentrate and wherein said organic acid component comprises between approximately 10 and 100% by weight of one or more acids selected from a group consisting of lactic acid, phosphoric acid, citric acid or gluconic acids.

7. The method of claim 1 wherein the said beverage product Isotonic Beverage and wherein the acid component comprises between approximately 10 and 100% by weight of one or more acids selected from a group consisting of lactic acid, phosphoric acid, citric acid or gluconic acids.

8. The method of claim 2 wherein the mineral salt is one or more salt constituents selected from a group consisting of calcium, magnesium, potassium, and zinc salt.

9. The method of claim 8 where said calcium is present in the form of one or more calcium compounds selected from a group consisting of calcium carbonate, calcium hydroxide, calcium oxide, calcium phosphate, calcium sulfate, calcium d-saccharate, and calcium chloride, and wherein the weight ratio of said acid component to calcium in said premix solution is between approximately 1 and 6.

10. The method of claim 8 where said magnesium is present in the form of one or more magnesium compounds selected from a group consisting of magnesium oxide, magnesium hydroxide, magnesium chloride, magnesium citrate, magnesium sulfate, and wherein the weight ratio of said acid component to said magnesium in said premix solution is between approximately 0.05 to 8.

11. The method of claim 8 where said potassium is present in the form of one or more potassium compounds selected from a group consisting of potassium oxide, potassium phosphate, potassium bicarbonate, potassium carbonate, potassium citrate, potassium chloride, potassium hydroxide, potassium hydrogen glucarate, and potassium sulfate, and wherein the weight ratio of said acid component to said potassium in said premix solution is between approximately 1 and 12.

12. The method of claim 8 where said zinc is present in the form of one or more zinc compounds selected from a group consisting zinc acetate, zinc oxide, zinc sulfate, zinc citrate, zinc carbonate, and wherein the weight ratio of said acid component to said zinc in said premix solution is between approximately 0.0001 and 1.8.

13. The method of claim 3 wherein the sugar content of said beverage substrate is from between approximately 20(to 80° Brix, and wherein said beverage product is produced as a single-strength, mineral supplemented fruit juice product having: not less than approximately 30% fruit juice; and a sugar content of between approximately 2° and 16° Brix.

14. The method of claim 3 wherein said beverage substrate is selected from a group consisting of the juices, extracts or brews of orange, apple, grape, cranberry, peach, melon, coconut, mango, papaya, pear, cherry, tea, coffee, or a combination of any of the foregoing.

15. The method of claim 13 wherein said beverage substrate is selected from a group consisting of the juices, extracts or brews of orange, apple, grape, cranberry, peach, melon, coconut, mango, papaya, pear, cherry, tea, coffee, or a combination of any of the foregoing.

16. The method in claim 6 wherein the sugar constituent of said fruit juice concentrate is between approximately 20° Brix and 80° Brix, and provides a concentrated mineral fortified fruit juice product having a sugar content of between approximately 5° and 75° Brix; wherein the concentrated mineral fortified fruit juice product provides upon dilution of said fruit juice concentrate, a single-strength, mineral fortified fruit juice product having not less than approximately 35% by weight fruit juice, a sugar content of between approximately 2° and 16° Brix; and mineral content between approximately 0.05 and 0.50% by weight.

17. The method of claim 16 wherein the concentrated fruit juice is concentrated juices, extracts or brews of orange, apple, grape, cranberry, peach, melon, coconut, mango, papaya, pear, cherry, tea, coffee, or a combination of any of the foregoing.

18. The method of claims 17 which comprises the further step of freezing said mineral fortified juice concentrate.
